(19) United States
(12) Patent Application Publication
(10) Pub. No.: US 2026/0177094 A1
(43) Pub. Date: Jun. 25, 2026

(54) PULL-TYPE RIVETING ASSEMBLY, PRODUCT, PRODUCT ASSEMBLY AND PRODUCT INSTALLATION METHOD

(71) Applicants: Tyco Electronics (Shanghai) Co., Ltd., Shanghai (CN); Stanley Black & Decker Engineered Fastening (Nantong) Co., Ltd., Nantong (CN)

(72) Inventors: Xiaoguang (Field) Sun, Shanghai (CN); Wei Yuan, Shanghai (CN); Yuchen Yang, Shanghai (CN); Xiao (Nichee) Zhou, Shanghai (CN); Xiaobing Li, Shanghai (CN); Kanwen Shen, Nantong (CN); Xiaoan Ji, Nantong (CN); Jia Li, Nantong (CN); Jian Xiao, Nantong (CN); Chengge Chang, Changtong (CN); Shijie Wei, Nantong (CN)

(73) Assignees: Tyco Electronics (Shanghai) Co., Ltd., Shanghai (CN); Stanley Black & Decker Engineered Fastening (Nantong) Co., Ltd., Nantong (CN)

(21) Appl. No.: 19/426,311

(22) Filed: Dec. 19, 2025

(30) Foreign Application Priority Data
Dec. 20, 2024 (CN) 202411898765.1

(51) Int. Cl. F16B 19/10; F16B 43/00

(52) U.S. Cl. CPC F16B 19/1036; F16B 43/00

(57) ABSTRACT

A pull-type riveting assembly includes a riveting nut including a positioning end, a bolt and a washer. The bolt is threaded with the riveting nut, and the washer is fitted onto the positioning end of the riveting nut. The assembly adapted such that with the washer engaged with the positioning end of the riveting nut, the riveting nut cannot rotate relative to the washer. The washer is adapted to engage with a fixed sleeve of a riveting tool to prevent the riveting nut from being rotated when being riveted by the riveting tool.

### CROSS-REFERENCE TO RELATED APPLICATION

This application claims the benefit of Chinese Patent Application No. CN202411898765.1 filed on Dec. 20, 2024 in the State Intellectual Property Office of China, the whole disclosure of which is incorporated herein by reference.

### FIELD OF THE INVENTION

The disclosure relates to a pull-type riveting assembly, a product comprising the pull-type riveting assembly, a product assembly comprising the product, and an installation method of the product.

### BACKGROUND OF THE INVENTION

In the prior art, a connector, especially a board end connector, is usually fastened with a bolt when assembled onto an installation panel of customer equipment. This requires the installation panel of the customer's equipment to have a threaded hole. When the installation panel of the customer's equipment is a very thin sheet metal part, due to the thinness of the sheet metal part, it is usually necessary to add a back plate on the inside of the sheet metal part and form a threaded hole in the back plate. In addition, in the prior art, if sealing is required, the back plate also needs to add a sealing ring structure to prevent water leakage. Due to the thickness of the back plate, it can provide certain strength support for the thin sheet metal part and prevent deformation under stress. However, adding the back plate will increase costs.

In the prior art, there is also a solution to fasten the connector to the installation panel. The plan first involves riveting the riveting nut on the installation panel. Then use a bolt to secure the connector to the installation panel. The disadvantage of this solution is that it requires the use of a riveting tool to first rivet the riveting nut to the installation panel, resulting in too many installation steps and higher costs.

### SUMMARY OF THE INVENTION

According to an embodiment of the present disclosure, a pull-type riveting assembly includes a riveting nut including a positioning end, a bolt and a washer. The bolt is threaded with the riveting nut, and the washer is fitted onto the positioning end of the riveting nut. The assembly adapted such that with the washer engaged with the positioning end of the riveting nut, the riveting nut cannot rotate relative to the washer. The washer is adapted to engage with a fixed sleeve of a riveting tool to prevent the riveting nut from being rotated when being riveted by the riveting tool.

### BRIEF DESCRIPTION OF DRAWINGS

The above and other features of the present invention will become more apparent by describing in detail exemplary embodiments thereof with reference to the accompanying drawings, in which:

FIG. 1 shows an illustrative perspective view of a connector according to an exemplary first embodiment of the present invention;

FIG. 2 shows an illustrative perspective view of an installation panel for installing the connector shown in FIG. 1 according to an exemplary first embodiment of the present invention;

FIG. 3 shows an illustrative assembly view of a connector and mounting panel according to an exemplary first embodiment of the present invention;

FIG. 4 shows an illustrative exploded view of the pull-type riveting assembly of a connector according to an exemplary first embodiment of the present invention;

FIG. 5 shows a cross-sectional view of a connector according to an exemplary first embodiment of the present invention;

FIG. 6 shows an illustrative exploded view of the pull-type riveting assembly of a connector according to an exemplary first embodiment of the present invention, where the pull-type riveting assembly has not yet been pre-installed onto the flange of the connector housing;

FIG. 7 shows a cross-sectional view of a pull-type riveting assembly of a connector according to an exemplary first embodiment of the present invention, wherein the pull-type riveting assembly has been pre-installed onto the flange of the connector housing;

FIG. 8 shows an illustrative exploded view of a connector and mounting panel according to an exemplary first embodiment of the present invention, where the pull-type riveting assembly has not yet been pre-installed on the mounting panel;

FIG. 9 shows an illustrative assembly view of a connector and a mounting panel according to an exemplary first embodiment of the present invention, where the pull-type riveting assembly has not yet been riveted to the mounting panel;

FIG. 10 shows an illustrative assembly view of a connector and mounting panel according to an exemplary first embodiment of the present invention, wherein the riveting tool is shown and the pull-type riveting assembly has not yet been riveted and fixed to the mounting panel;

FIG. 11 shows an illustrative assembly view of a connector and mounting panel according to an exemplary first embodiment of the present invention, wherein a riveting tool is shown and the pull-type riveting assembly has been riveted and fixed to the mounting panel;

FIG. 12 shows a cross-sectional view of a connector and mounting panel according to another exemplary first embodiment of the present invention;

FIG. 13 shows an illustrative perspective view of a connector according to an exemplary second embodiment of the present invention;

FIG. 14 shows an illustrative exploded view of the pull-type riveting assembly of a connector according to an exemplary second embodiment of the present invention;

FIG. 15 shows a cross-sectional view of a connector according to an exemplary second embodiment of the present invention; and

FIG. 16 shows an illustrative assembly view of a connector and mounting panel according to an exemplary second embodiment of the present invention.

The features disclosed in this disclosure will become more apparent in the following detailed description in conjunction with the accompanying drawings, where similar reference numerals always identify the corresponding components. In the accompanying drawings, similar reference numerals typically represent identical, functionally similar, and/or structurally similar components. Unless otherwise stated, the drawings provided throughout the entire disclosure should not be construed as drawings drawn to scale.

### DETAILED DESCRIPTION

Exemplary embodiments of the present disclosure will be described hereinafter in detail with reference to the attached drawings, wherein like reference numerals refer to like elements. The present disclosure may, however, be embodied in many different forms and should not be construed as being limited to the embodiments set forth herein; rather, these embodiments are provided so that the present disclosure will convey the concept of the disclosure to those skilled in the art. Exemplary embodiments of the present disclosure will be described hereinafter in detail with reference to the attached drawings, wherein the like reference numerals refer to the like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

According to an embodiment of the present disclosure, there is provided a pull-type riveting assembly. The pull-type riveting assembly comprises: a riveting nut, including a positioning end; a bolt threaded with the riveting nut; and a washer which is fitted onto the positioning end of the riveting nut. The washer is engaged with the positioning end of the riveting nut, so that the riveting nut cannot rotate relative to the washer, the washer is adapted to engage with a fixed sleeve of a riveting tool to prevent the riveting nut from being rotated when being riveted by the riveting tool.

According to another embodiment, there is provided a pull-type riveting assembly. The pull-type riveting assembly comprises: multiple riveting nuts, each riveting nut comprising a positioning end; multiple bolts which are respectively threaded with the multiple riveting nuts; and a single pad which is formed with multiple positioning holes. The multiple positioning holes of the pad are respectively engaged with the positioning ends of the multiple riveting nuts, so that the riveting nuts cannot rotate relative to the pad; the pad is adapted to be pre-installed onto a first component through the multiple riveting nuts, so that the pad and the riveting nut do not rotate relative to the first component when the riveting nut is riveted with the riveting tool.

According to another general concept of the present invention, there is provided a product. The product comprises: a first component which is formed with a first through-hole; and the above pull-type riveting assembly which is detachably pre-installed on the first component. The positioning end of the riveting nut passes through the first through-hole in the first component, and the rivet body of the riveting nut is used to pass through a second through-hole in a second component, the washer is axially compressed between the head of the bolt and the first component, and the first flange of the riveting nut and the first component are adapted to press against one side of the second component. When the rivet body of the riveting nut passes through the second through hole in the second component and the bolt is tightened by the riveting tool, the rivet body deforms under the pulling of the bolt and forms a second flange against the other side of the second component to rivet the riveting nut to the second component and fasten the first component and the second component together.

According to another embodiment of the present disclosure, there is provided a product assembly. The product assembly comprises: a second component which is formed with a second through-hole; and the above product. The riveting nut of the pull-type riveting assembly passes through the second through-hole of the second component. During the process of tightening the bolt of the pull-type riveting assembly with the riveting tool, the first flange of the riveting nut is pressed against one side of the second component and the riveting nut is pulled down by the bolt to form a second flange that is pressed against the other side of the second component, so that the riveting nut is riveted to the second component.

According to another general concept of the present invention, there is provided a product installation method. The product installation method comprises following steps: providing the above pull-type riveting assembly; pre installing the pull-type riveting assembly onto a first component of a product; passing the rivet body of the riveting nut through a second through-hole of a second component; and using a riveting tool to tighten the bolt of the pull-type riveting assembly to rivet the riveting nut to the second component and tighten the first component to the second component.

### First Embodiment

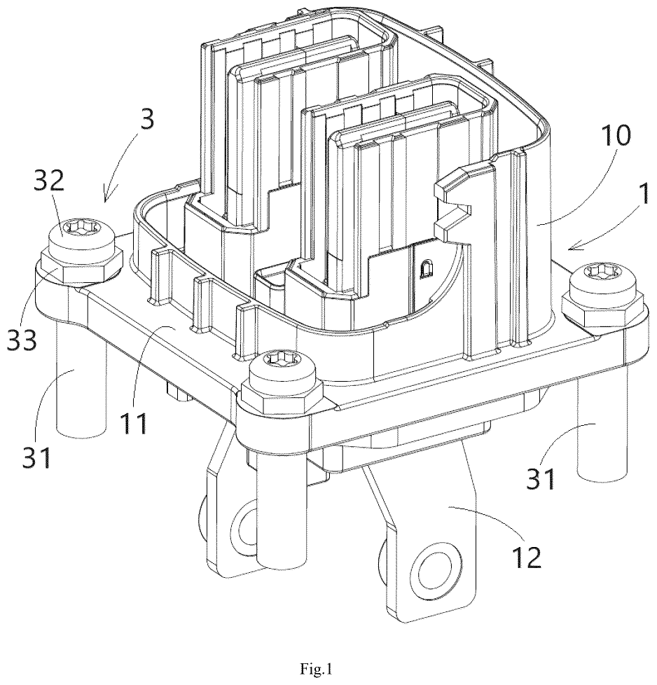

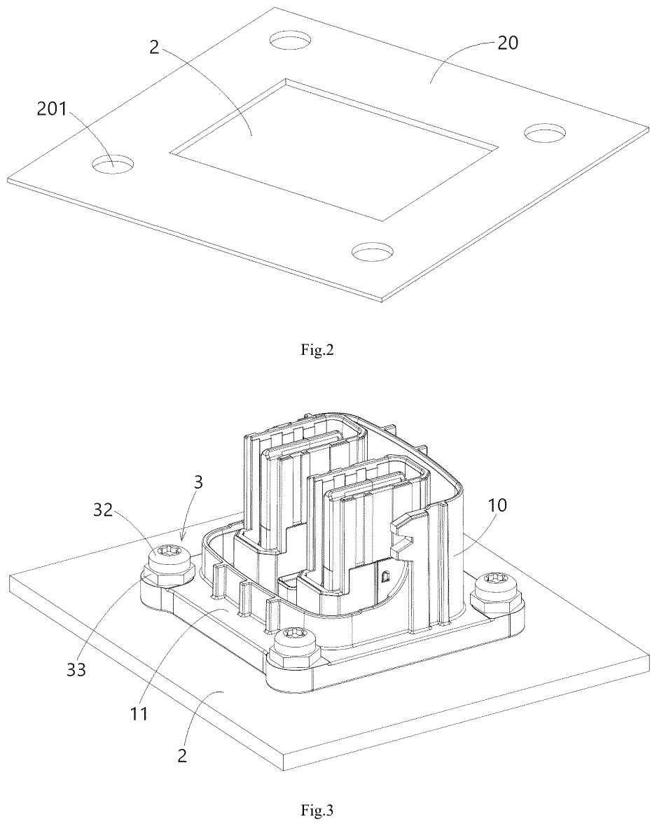

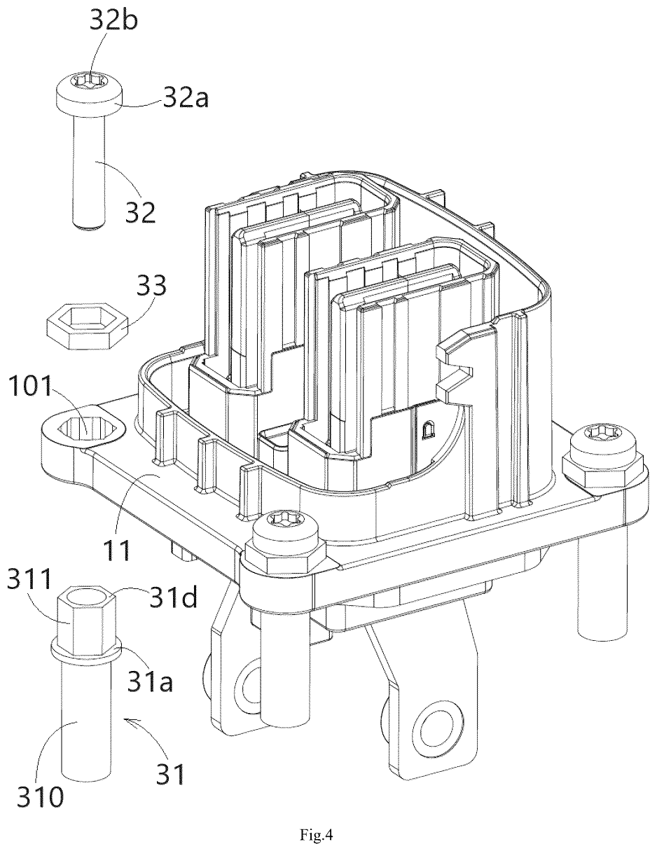

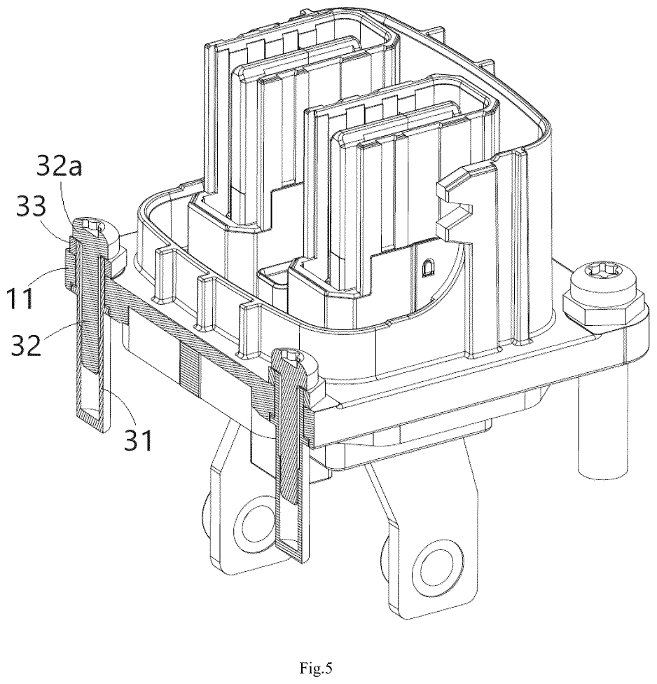

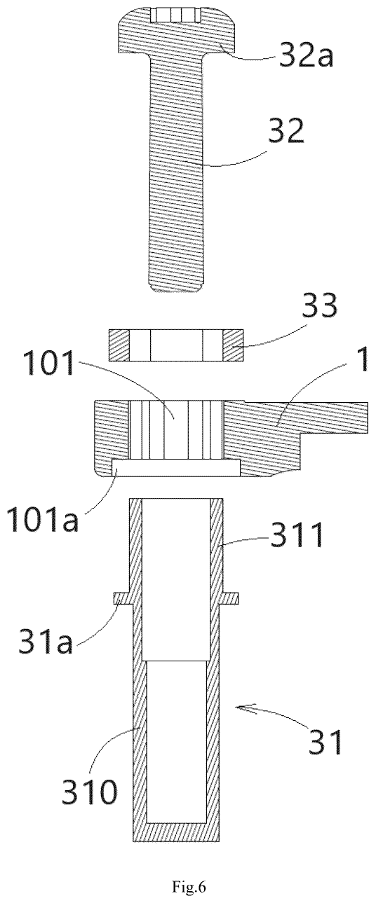

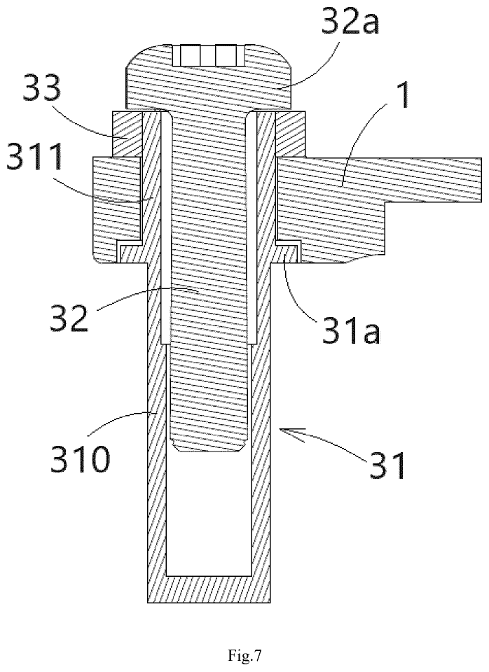

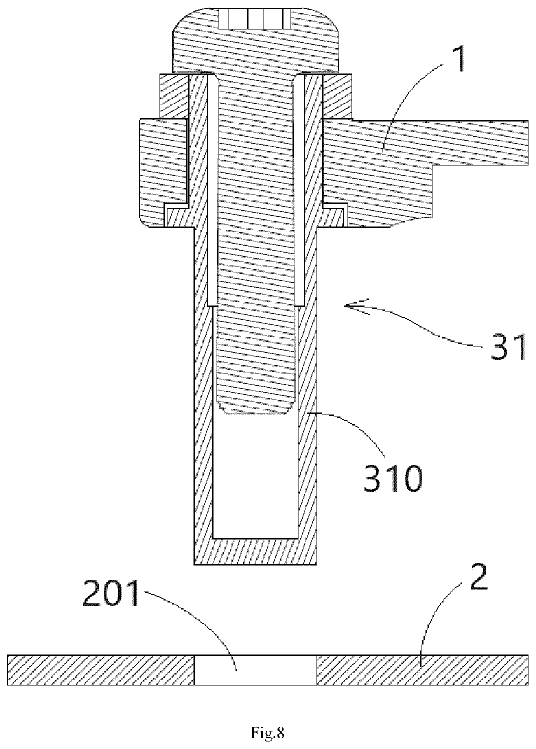

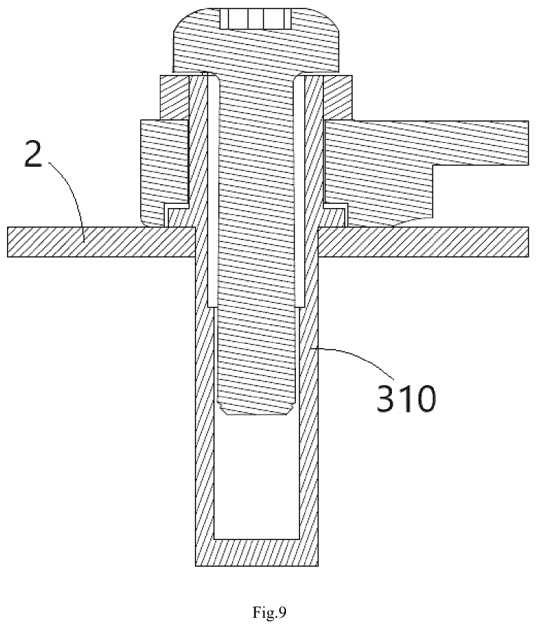

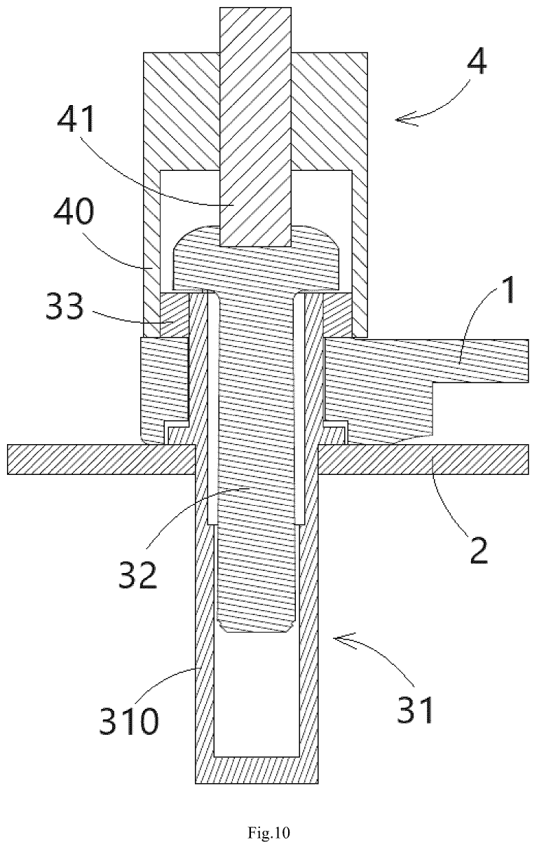

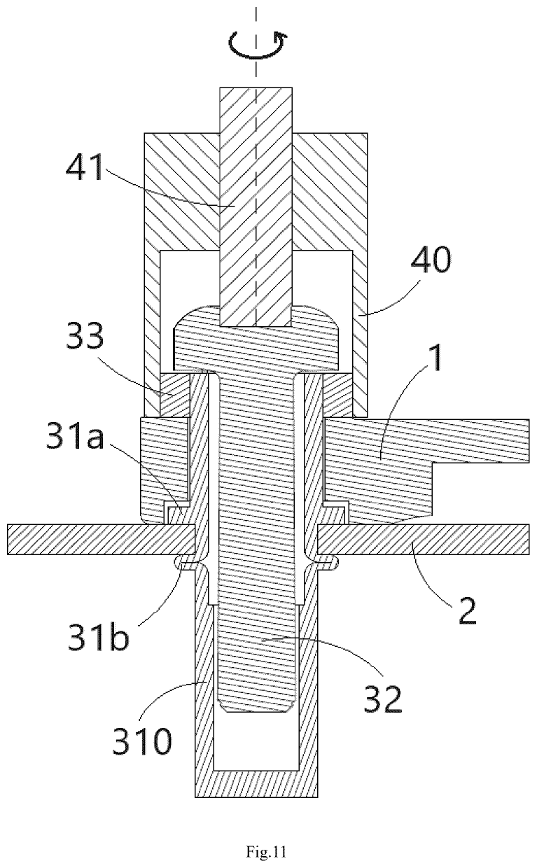

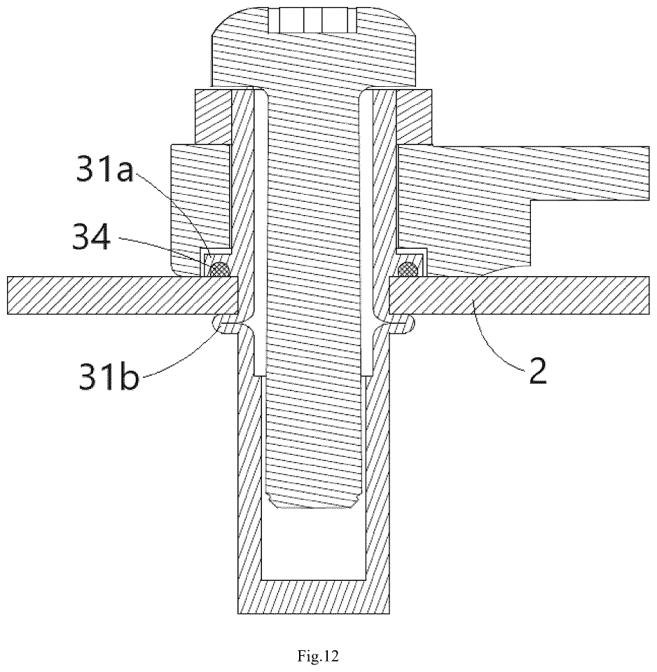

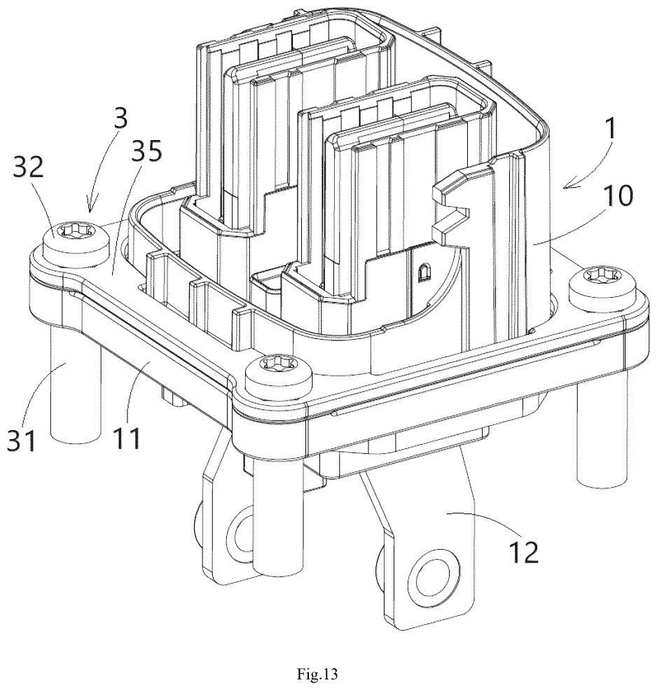

FIGS. 1-12 show the first embodiment according to the present invention. Among them, FIG. 1 shows an illustrative perspective view of a connector according to an exemplary first embodiment of the present invention. FIG. 2 shows an illustrative perspective view of an installation panel for installing the connector shown in FIG. 1 according to an exemplary first embodiment of the present invention. FIG. 3 shows an illustrative assembly view of a connector and mounting panel according to an exemplary first embodiment of the present invention. FIG. 4 shows an illustrative exploded view of the pull-type riveting assembly of a connector according to an exemplary first embodiment of the present invention. FIG. 5 shows a cross-sectional view of a connector according to an exemplary first embodiment of the present invention. FIG. 6 shows an illustrative exploded view of the pull-type riveting assembly of a connector according to an exemplary first embodiment of the present invention, where the pull-type riveting assembly has not yet been pre-installed onto the flange of the connector housing. FIG. 7 shows a cross-sectional view of a pull-type riveting assembly of a connector according to an exemplary first embodiment of the present invention, wherein the pull-type riveting assembly has been pre-installed onto the flange of the connector housing. FIG. 8 shows an illustrative exploded view of a connector and mounting panel according to an exemplary first embodiment of the present invention, where the pull-type riveting assembly has not yet been pre-installed on the mounting panel. FIG. 9 shows an illustrative assembly view of a connector and a mounting panel according to an exemplary first embodiment of the present invention, where the pull-type riveting assembly has not yet been riveted to the mounting panel. FIG. 10 shows an illustrative assembly view of a connector and mounting panel according to an exemplary first embodiment of the present invention, wherein the riveting tool is shown and the pull-type riveting assembly has not yet been riveted and fixed to the mounting panel. FIG. 11 shows an illustrative assembly view of a connector and mounting panel according to an exemplary first embodiment of the present invention, wherein a riveting tool is shown and the pull-type riveting assembly has been riveted and fixed to the mounting panel. FIG. 12 shows a cross-sectional view of a connector and mounting panel according to another exemplary first embodiment of the present invention.

As shown in FIGS. 1-12, in an exemplary embodiment of the present invention, a pull-type riveting assembly 3 is disclosed. The pull-type riveting assembly 3 includes a riveting nut 31, a bolt 32, and a washer 33. The riveting nut 31 includes a positioning end 311. The bolt 32 is threaded with the riveting nut 31. The washer 33 is fitted onto the positioning end 311 of the riveting nut 31. The positioning end 311 of the washer 33 is engaged with the riveting nut 31, so that the riveting nut 31 cannot rotate relative to the washer 33. The washer 33 is suitable for engaging with a fixed sleeve 40 of a riveting tool 4 to prevent the riveting nut 31 from being rotated when being riveted by the riveting tool 4. During the riveting process, a rotor 41 of the riveting tool 4 engages with the plum blossom groove 32b on the head 32a of the bolt 32, driving the bolt 32 to rotate and complete the riveting operation of the riveting nut 31.

The inner contour of the washer 33 is non-circular, and the outer contour of the positioning end 311 of the riveting nut 31 is non-circular and matches the inner contour of the washer 33, so that the riveting nut 31 cannot rotate relative to the washer 33. The inner contour of the washer 33 and the outer contour of the positioning end 311 are polygonal or elliptical. In the illustrated embodiment, the inner contour of the washer 33 and the outer contour of the positioning end 311 of the riveting nut 31 are regular hexagons. However, the present invention is not limited to this, and the inner contour of the washer 33 and the outer contour of the positioning end 311 of the riveting nut 31 may also be a regular quadrilateral, a regular octagon, or other suitable shapes.

In another exemplary embodiment of the present invention, the washer 33 may be threaded onto the positioning end 311 of the riveting nut 31 to join the two together . In an exemplary embodiment of the present invention, the outer contour of the washer 33 is non-circular, which is used to match the non-circular inner contour of the fixed sleeve 40 of the riveting tool 4, so that the washer 33 and the riveting nut 31 cannot rotate relative to the fixed sleeve 40 of the riveting tool 4.

In an exemplary embodiment of the present invention, the outer contour of the washer 33 and the inner contour of the fixed sleeve 40 of the riveting tool 4 may be polygonal or elliptical. In the illustrated embodiment, the outer contour of the washer 33 and the inner contour of the fixed sleeve 40 of the riveting tool 4 are regular hexagons. However, the present invention is not limited to this, and the outer contour of the washer 33 and the inner contour of the fixed sleeve 40 of the riveting tool 4 may also be a regular quadrilateral, a regular octagon, or other suitable shapes.

In another exemplary embodiment of the present invention, an axially extending protruding key is formed on the outer peripheral surface of the washer 33, which is used to engage with the keyway on the inner peripheral surface of the fixed sleeve 40 of the riveting tool 4, so that the washer 33 and the riveting nut 31 cannot rotate relative to the fixed sleeve 40 of the riveting tool 4. An axially extending keyway is formed on the outer peripheral surface of the washer 33, which is used to engage with a protruding key on the inner peripheral surface of the fixed sleeve 40 of the riveting tool 4, so that the washer 33 and the riveting nut 31 cannot rotate relative to the fixed sleeve 40 of the riveting tool 4.

The riveting nut 31 further comprises a rivet body 310 and a first flange 31a. The rivet body 310 is axially opposite to the positioning end 311. The first flange 31a is located between the positioning end 311 and the rivet body 310. The bolt 32 is threaded with the rivet body 310, and the head of the bolt 32 is used to axially rest against the end face 31d of the positioning end 311 of the riveting nut 31 and the end face of the washer 33.

The positioning end 311 of the riveting nut 31 is used to pass through a first through-hole 101 in a first component 1, and the rivet body 310 of the riveting nut 31 is used to pass through a second through-hole 201 in a second component 2. The washer 33 is suitable for being axially compressed between the head 32a of the bolt 32 and the first component 1, and the first flange 31 of the riveting nut 31 and the first component 1 are suitable for being pressed against one side of the second component 2. When the riveting nut 31 is installed on the first component 1 and the second component 2 and the bolt 32 is tightened by the riveting tool 4, the rivet body 310 deforms under the pulling of the bolt 32 and forms a second flange 31b that rests against the other side of the second component 2, to rivet the riveting nut 31 to the second component 2 and fasten the first component 1 and the second component 2 together.

A sealing ring installation groove is formed on the first flange 31a of the riveting nut 31, and the pull-type riveting assembly 3 further includes a sealing ring 34 installed in the sealing ring installation groove. When the riveting nut 31 is riveted to the second component 2, the sealing ring 34 is axially compressed between the first flange 31a of the riveting nut 31 and the second component 2 to achieve sealing between the two. The bottom of the rivet body 310 of the riveting nut 31 is closed to prevent metal powder generated during the rivet process from falling out of the riveting nut 31. However, the present invention is not limited to the illustrated embodiment. For example, in another exemplary embodiment of the present invention, the bottom of the rivet body 310 of the riveting nut 31 is open to allow the bolt to pass through the rivet body 310 during the riveting process.

A product (illustrated connector) is also disclosed. This product includes: a first component 1 and the pull-type riveting assembly 3. The first component 1 is formed with a first through-hole 101. The pull-type riveting assembly 3 is detachably pre-installed onto the first component 1. The positioning end 311 of the riveting nut 31 passes through the first through-hole 101 in the first component 1, and the rivet body 310 of the riveting nut 31 is used to pass through a second through-hole 201 in a second component 2. The washer 33 is axially compressed between the head 32a of the bolt 32 and the first component 1, and the first flange 31 of the riveting nut 31 and the first component 1 are adapted to press against one side of the second component 2. When the rivet body 310 of the riveting nut 31 passes through the second through hole 201 in the second component 2 and the bolt 32 is tightened by the riveting tool 4, the rivet body 310 deforms under the pulling of the bolt 32 and forms a second flange 31b that rests against the other side of the second component 2, to rivet the riveting nut 31 to the second component 2 and fasten the first component 1 and the second component 2 together.

In the illustrated embodiment, a receiving recess 101a is formed on the lower side of the first component 1 facing the second component 2, which is communicated with the first through-hole 101. The first flange 31a of the riveting nut 31 is received and positioned in the receiving recess 101a.

During the pre-installation of the pull-type riveting assembly 3, the positioning end 311 of the riveting nut 31 is inserted into the first through-hole 101 from the lower side of the first component 1, and the bolt 32 is screwed into the riveting nut 31 from the upper side of the first component 1.

As shown in FIGS. 1 to 12, in the illustrated embodiment, the product is a connector, which includes a connector housing 10 and terminals 12 arranged in the connector housing 10. The first component 1 is a connector housing 10, which has a flange 11 for mounting the connector onto the second component 2, and a first through-hole 101 is formed in the flange 11.

As shown in FIGS. 1 to 12, in another exemplary embodiment of the present invention, a product assembly is also disclosed. The product assembly includes: a second component 2 and the aforementioned product. The second component 2 is formed with a second through-hole 201. The riveting nut 31 of the pull-type riveting assembly 3 of the product passes through the second through-hole 201 of the second component 2. During the process of tightening the bolt 32 of the pull-type riveting assembly 3 with the riveting tool 4, the first flange 31a of the riveting nut 31 is pressed against one side of the second component 2, and the riveting nut 31 is pulled by the bolt 32 to form a second flange 31b that is pressed against the other side of the second component 2, so that the riveting nut 31 is riveted to the second component 2.

As shown in FIGS. 1 to 12, in the illustrated embodiment, the aforementioned product is a connector, which includes a connector housing 10 and terminals 12 arranged in the connector housing 10. The first component 1 is the connector housing 10, which has a flange 11 and a first through-hole 101 formed in the flange 11. The second component 2 is a mounting panel with a mounting opening 20 formed to allow a portion of the connector to pass through. The mounting opening 20 of the second component 2 has a rolled edge to prevent deformation of the edge of the mounting opening 20 when tightening the bolt 32.

In another exemplary embodiment of the present invention, a product installation method is also disclosed. The installation method of this product includes the following steps:
S10: Providing the aforementioned pull-type riveting assembly 3;
S20: Pre installing the pull-type riveting assembly 3 onto the first component 1 of the product;
S30: Passing the rivet body 310 of the riveting nut 31 through the second through-hole 201 of the second component 2; and
S40: Using the riveting tool 4 to tighten the bolt 32 of pull-type riveting assembly 3, in order to rivet the riveting nut 31 to the second component 2 and tighten the first component 1 to the second component 2.

### Second Embodiment

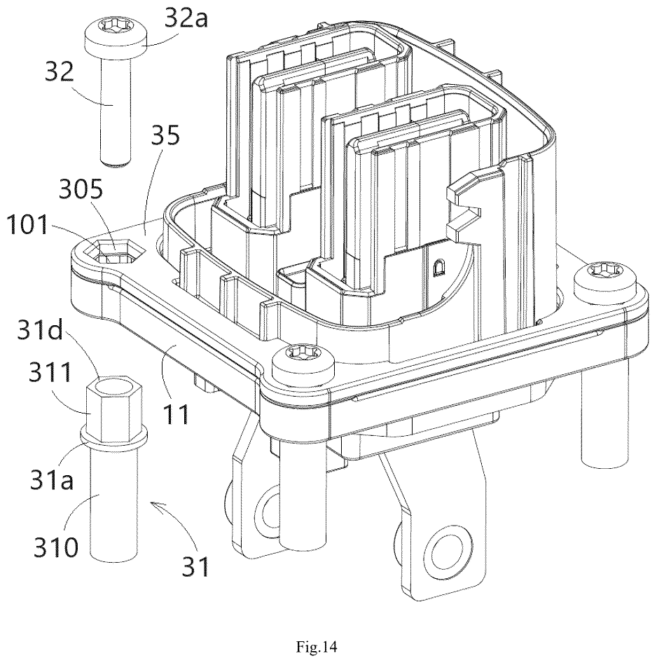

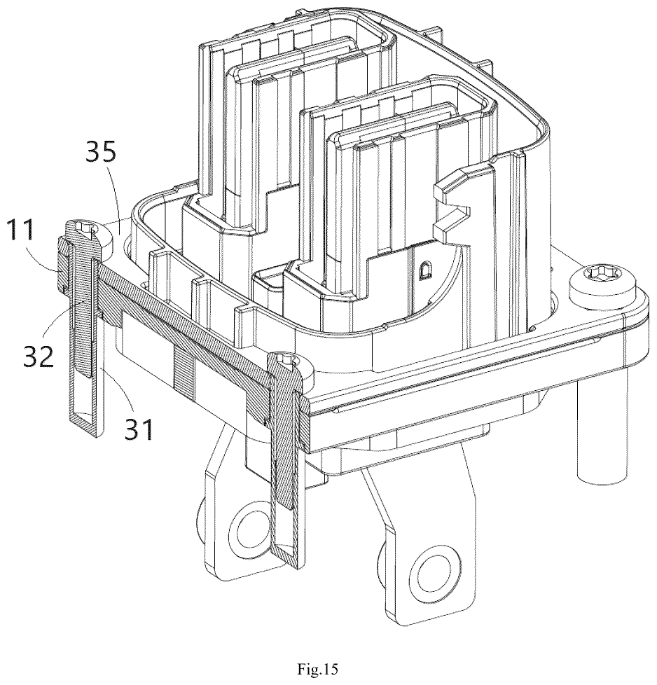

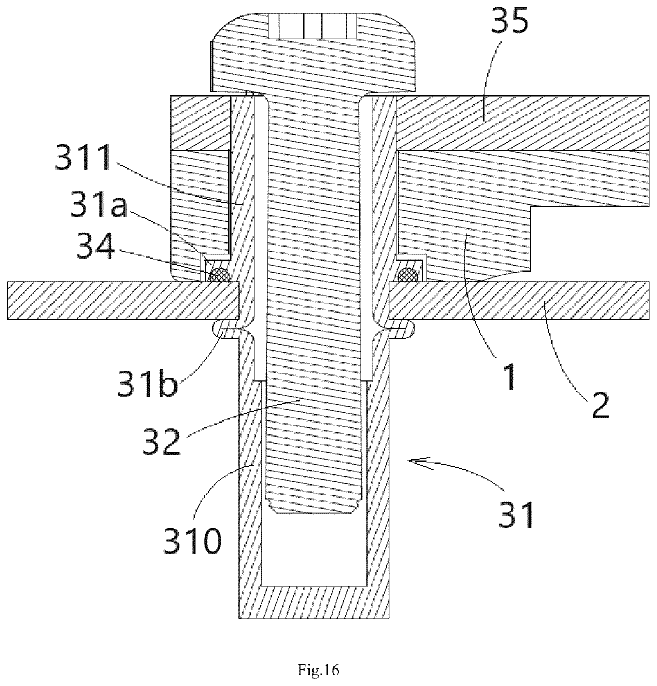

FIGS. 13-16 show a second embodiment according to the present invention. Among them, FIG. 13 shows an illustrative perspective view of a connector according to an exemplary second embodiment of the present invention. FIG. 14 shows an illustrative exploded view of the pull-type riveting assembly of a connector according to an exemplary second embodiment of the present invention. FIG. 15 shows a cross-sectional view of a connector according to an exemplary second embodiment of the present invention. FIG. 16 shows an illustrative assembly view of a connector and mounting panel according to an exemplary second embodiment of the present invention.

A difference between the second embodiment shown in FIGS. 13-16 and the first embodiment shown in FIGS. 1-12 is that a common pad 35 replaces multiple washers 33 in the first embodiment. Other technical features are basically the same as those of the first embodiment, which can be referred to in FIGS. 1 to 12.

As shown in FIGS. 13-16, in an exemplary embodiment of the present invention, a pull-type riveting assembly 3 is disclosed. The pull-type riveting assembly 3 includes multiple riveting nuts 31, multiple bolts 32, and a single pad 35. Each riveting nut 31 includes a positioning end 311. Multiple bolts 32 are respectively threaded with multiple riveting nuts 31. The single pad 35 is formed with multiple positioning holes 305. The multiple positioning holes 305 of the pad 35 are respectively engaged with the positioning ends 311 of the multiple riveting nuts 31, so that the riveting nuts 31 cannot rotate relative to the pad 35. The pad 35 is suitable for pre installing onto a first component 1 through multiple riveting nuts 31, so that when using a riveting tool 4 to rivet the riveting nut 31, the pad 35 and the riveting nut 31 will not rotate relative to the first component 1.

In an exemplary embodiment of the present invention, the inner contour of the positioning hole 305 of the pad 35 is non-circular, and the outer contour of the positioning end 311 of the riveting nut 31 is non-circular and matches the inner contour of the positioning hole 305 of the pad 35, so that the riveting nut 31 cannot rotate relative to the pad 35.

The inner contour of the positioning hole 305 of the pad 35 and the outer contour of the positioning end 311 are polygonal or elliptical. For example, in the illustrated embodiment, the inner contour of the positioning hole 305 of the pad 35 and the outer contour of the positioning end 311 are regular hexagons. However, the present invention is not limited to the illustrated embodiments. For example, the inner contour of the positioning hole 305 of the pad 35 and the outer contour of the positioning end 311 may be a regular quadrilateral, a regular octagon, or other suitable shapes.

The riveting nut 31 further comprises a rivet body 310 and a first flange 31a. The rivet body 310 is axially opposite to the positioning end 311. The first flange 31a is located between the positioning end 311 and the rivet body 310. The bolt 32 is connected to the rivet body 310 by threads, and the head 32a of the bolt 32 is used to axially rest against the end face 31d of the positioning end 311 of the riveting nut 31 and the surface of the pad 35.

The positioning end 311 of the riveting nut 31 is used to pass through a first through-hole 101 in a first component 1, and the rivet body 310 of the riveting nut 31 is used to pass through a second through-hole 201 in a second component 2. The pad 35 is suitable for being axially compressed between the head 32a of the bolt 32 and the first component 1, and the first flange 31 of the riveting nut 31 and the first component 1 are suitable for being pressed against one side of the second component 2. When the riveting nut 31 is installed on the first component 1 and the second component 2 and the bolt 32 is tightened by the riveting tool 4, the rivet body 310 deforms under the pulling of the bolt 32 and forms a second flange 31b that rests against the other side of the second component 2, to rivet the riveting nut 31 to the second component 2 and fasten the first component 1 and the second component 2 together.

A sealing ring installation groove is formed on the first flange 31a of the riveting nut 31, and the pull-type riveting assembly 3 further includes a sealing ring 34 installed in the sealing ring installation groove. When the riveting nut 31 is riveted to the second component 2, the sealing ring 34 is axially compressed between the first flange 31a of the riveting nut 31 and the second component 2 to achieve sealing between the two.

The bottom of the rivet body 310 of the riveting nut 31 is closed to prevent metal powder generated during the rivet process from falling out of the riveting nut 31. However, the present invention is not limited to the illustrated embodiment. For example, in another exemplary embodiment of the present invention, the bottom of the rivet body 310 of the riveting nut 31 is open to allow the bolt to pass through the rivet body 310 during the riveting process.

A product (illustrated connector) is also disclosed. This product includes: a first component 1 and the pull-type riveting assembly 3. The first component 1 is formed with a first through-hole 101. The pull-type riveting assembly 3 is detachably pre-installed onto the first component 1. The positioning end 311 of the riveting nut 31 passes through the first through-hole 101 in the first component 1, and the rivet body 310 of the riveting nut 31 is used to pass through the second through-hole 201 in the second component 2. The pad 35 is axially compressed between the head 32a of the bolt 32 and the first component 1, and the first flange 31a of the riveting nut 31 and the first component 1 are adapted to press against one side of the second component 2. When the rivet body 310 of the riveting nut 31 passes through the second through hole 201 in the second component 2 and the bolt 32 is tightened by the riveting tool 4, the rivet body 310 deforms under the pulling of the bolt 32 and forms a second flange 31b that rests against the other side of the second component 2, to rivet the riveting nut 31 to the second component 2 and fasten the first component 1 and the second component 2 together.

A receiving recess 101a is formed on the lower side of the first component 1 facing the second component 2, which is communicated with the first through-hole 101. The first flange 31a of the riveting nut 31 is received and positioned in the receiving recess 101a.

During the pre-installation of the pull-type riveting assembly 3, the positioning end 311 of the riveting nut 31 is inserted into the first through-hole 101 from the lower side of the first component 1, and the bolt 32 is screwed into the riveting nut 31 from the upper side of the first component 1.

The product is a connector, which includes a connector housing 10 and terminals 12 arranged in the connector housing 10. The first component 1 is a connector housing 10, which has a flange 11 for mounting the connector onto the second component 2, and a first through-hole 101 is formed in the flange 11.

In another exemplary embodiment of the present invention, a product assembly is also disclosed. The product assembly includes: a second component 2 and the aforementioned product. The second component 2 is formed with a second through-hole 201. The riveting nut 31 of the pull-type riveting assembly 3 of the product passes through the second through-hole 201 of the second component 2. During the process of tightening the bolt 32 of the pull-type riveting assembly 3 with the riveting tool 4, the first flange 31a of the riveting nut 31 is pressed against one side of the second component 2, and the riveting nut 31 is pulled by the bolt 32 to form a second flange 31b that is pressed against the other side of the second component 2, so that the riveting nut 31 is riveted to the second component 2.

The aforementioned product is a connector, which includes a connector housing 10 and terminals 12 arranged in the connector housing 10. The first component 1 is the connector housing 10, which has a flange 11 and a first through-hole 101 formed in the flange 11. The second component 2 is a mounting panel with a mounting opening 20 formed to allow a portion of the connector to pass through. The mounting opening 20 of the second component 2 has a rolled edge to prevent deformation of the edge of the mounting opening 20 when tightening the bolt 32.

In another exemplary embodiment of the present invention, a product installation method is also disclosed. The installation method of this product includes the following steps:
S10: Providing the aforementioned pull-type riveting assembly 3;
S20: Pre installing the pull-type riveting assembly 3 onto the first component 1 of the product;
S30: Passing the rivet body 310 of the riveting nut 31 through the second through-hole 201 of the second component 2; and
S40: Using the riveting tool 4 to tighten the bolt 32 of pull-type riveting assembly 3, in order to rivet the riveting nut 31 to the second component 2 and tighten the first component 1 to the second component 2.

It should be appreciated for those skilled in this art that the above embodiments are intended to be illustrated, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

1. A pull-type riveting assembly, comprising:
a riveting nut, including a positioning end;
a bolt threaded with the riveting nut; and
a washer which is fitted onto the positioning end of the riveting nut, the washer is engaged with the positioning end of the riveting nut such that the riveting nut cannot rotate relative to the washer, the washer is adapted to engage with a fixed sleeve of a riveting tool to prevent the riveting nut from being rotated when being riveted by the riveting tool.

2. The pull-type riveting assembly according to claim 1, wherein the inner contour of the washer is non-circular, and the outer contour of the positioning end of the riveting nut is non-circular and matches the inner contour of the washer, so that the riveting nut cannot rotate relative to the washer.

3. The pull-type riveting assembly according to claim 2, wherein the inner contour of the washer and the outer contour of the positioning end are polygonal or elliptical.

4. The pull-type riveting assembly according to claim 1, wherein the outer contour of the washer is non-circular and is adapted to match the non-circular inner contour of the fixed sleeve of the riveting tool, so that the washer and the riveting nut cannot rotate relative to the fixed sleeve of the riveting tool.

5. The pull-type riveting assembly according to claim 4, wherein the outer contour of the washer and the inner contour of the fixed sleeve of the riveting tool are polygonal or elliptical.

6. The pull-type riveting assembly according to claim 1, wherein an axially extending protruding key is formed on the outer peripheral surface of the washer, and is adapted to engage with the keyway on the inner peripheral surface of the fixed sleeve of the riveting tool, so that the washer and the riveting nut cannot rotate relative to the fixed sleeve of the riveting tool.

7. The pull-type riveting assembly according to claim 1, wherein an axially extending keyway is formed on the outer peripheral surface of the washer, and is adapted to engage with a protruding key on the inner peripheral surface of the fixed sleeve of the riveting tool, so that the washer and the riveting nut cannot rotate relative to the fixed sleeve of the riveting tool.

8. The pull-type riveting assembly according to claim 1, wherein the riveting nut further comprises:
a rivet body which is axially opposite to the positioning end; and
a first flange which is located between the positioning end and the rivet body, the bolt is threaded with the rivet body, and the head of the bolt is used to axially rest on the end face (d) of the positioning end of the riveting nut and the end face of the washer.

9. The pull-type riveting assembly according to claim 8, wherein:
the positioning end of the riveting nut is used to pass through a first through-hole in the first component, and the rivet body of the riveting nut is adapted to pass through a second through-hole in a second component;
the washer is adapted to be axially compressed between the head of the bolt and the first component, and the first flange of the riveting nut and the first component are adapted to be pressed against one side of the second component; and
when the riveting nut is installed on the first component and the second component and the bolt is tightened by the riveting tool, the rivet body deforms under the pulling of the bolt and forms a second flange that rests against the other side of the second component to rivet the riveting nut to the second component and fasten the first component and the second component together.

10. The pull-type riveting assembly according to claim 9, wherein:
a sealing ring installation groove is formed on the first flange of the riveting nut, and the pull-type riveting assembly further comprises a sealing ring installed in the sealing ring installation groove; and
when the riveting nut is riveted to the second component, the sealing ring is axially compressed between the first flange of the riveting nut and the second component to achieve sealing between the two.

11. The pull-type riveting assembly according to claim 8, wherein:
the bottom of the rivet body of the riveting nut is closed to prevent metal powder generated during the riveting process from falling out of the riveting nut; or
the bottom of the rivet body of the riveting nut is open to allow the bolt to pass through the rivet body during the riveting process.

12. A pull-type riveting assembly, comprising:
multiple riveting nuts, each riveting nut comprising a positioning end;
multiple bolts which are respectively threaded with the multiple riveting nuts; and
a single pad which is formed with multiple positioning holes, wherein:
the multiple positioning holes of the pad are respectively engaged with the positioning ends of the multiple riveting nuts, so that the riveting nuts cannot rotate relative to the pad; and
the pad is adapted to be pre-installed onto a first component through the multiple riveting nuts, so that the pad and the riveting nut do not rotate relative to the first component when the riveting nut is riveted with the riveting tool.

13. The pull-type riveting assembly according to claim 12, wherein the inner contour of the positioning hole of the pad is non-circular, and the outer contour of the positioning end of the riveting nut is non-circular and matches the inner contour of the positioning hole of the pad, so that the riveting nut cannot rotate relative to the pad.

14. The pull-type riveting assembly according to claim 13, wherein the inner contour of the positioning hole of the pad and the outer contour of the positioning end are polygonal or elliptical.

15. The pull-type riveting assembly according to claim 12, wherein the riveting nut further comprises:
a rivet body which is axially opposite to the positioning end; and
a first flange which is located between the positioning end and the rivet body,
wherein the bolt is threaded with the rivet body, and the head of the bolt is used to axially rest against an end face of the positioning end of the riveting nut and the surface of the washer.

16. The pull-type riveting assembly according to claim 15, wherein:
the positioning end of the riveting nut is used to pass through a first through-hole in a first component, and the rivet body of the riveting nut is used to pass through a second through-hole in a second component;
the washer is adapted to be axially compressed between the head of the bolt and the first component, and the first flange of the riveting nut and the first component are adapted to be pressed against one side of the second component; and
when the riveting nut is installed on the first component and the second component and the bolt is tightened by the riveting tool, the rivet body deforms under the pulling of the bolt and forms a second flange that rests against the other side of the second component to rivet the riveting nut to the second component and fasten the first component and the second component together.

17. The pull-type riveting assembly according to claim 16, wherein:
a sealing ring installation groove is formed on the first flange of the riveting nut, and the pull-type riveting assembly further comprises a sealing ring installed in the sealing ring installation groove; and
when the riveting nut is riveted to the second component, the sealing ring is axially compressed between the first flange of the riveting nut and the second component to achieve sealing between the two.

18. The pull-type riveting assembly according to claim 15, wherein:
the bottom of the rivet body of the riveting nut is closed to prevent metal powder generated during the riveting process from falling out of the riveting nut; or
the bottom of the rivet body of the riveting nut is open to allow the bolt to pass through the rivet body during the riveting process.

19. A product, comprising:
a first component which is formed with a first through-hole; and
the pull-type riveting assembly according to claim 1, detachably pre-installed on the first component, wherein:
the positioning end of the riveting nut passes through the first through-hole in the first component, and the rivet body of the riveting nut is used to pass through a second through-hole in a second component;
the washer is axially compressed between the head of the bolt and the first component, and the first flange of the riveting nut and the first component are adapted to press against one side of the second component;
when the rivet body of the riveting nut passes through the second through hole in the second component and the bolt is tightened by the riveting tool, the rivet body deforms under the pulling of the bolt and forms a second flange against the other side of the second component to rivet the riveting nut to the second component and fasten the first component and the second component together.

20. The product according to claim 19, wherein a receiving recess is formed on the lower side of the first component facing the second component, the receiving recess is communicated with the first through-hole, and the first flange of the riveting nut is received and positioned in the receiving recess.

21. The product according to claim 20, wherein during the pre-installation of the pull-type riveting assembly, the positioning end of the riveting nut is inserted into the first through-hole from the lower side of the first component, and the bolt is screwed into the riveting nut from the upper side of the first component.

22. The product according to claim 19, wherein:
the product is a connector, which comprises a connector housing and a terminal arranged in the connector housing; and
the first component is the connector housing, which has a flange for mounting the connector onto the second component, and the first through-hole is formed in the flange.

23. A product assembly, comprising:
a second component which is formed with a second through-hole; and
the product as claimed in claim 19, wherein the riveting nut of the pull-type riveting assembly passes through the second through-hole of the second component, wherein during the process of tightening the bolt of the pull-type riveting assembly with the riveting tool, the first flange of the riveting nut is pressed against one side of the second component and the riveting nut is pulled down by the bolt to form a second flange that is pressed against the other side of the second component, so that the riveting nut is riveted to the second component.

24. The product assembly according to claim 23, wherein:
the product is a connector, which comprises a connector housing and a terminal arranged in the connector housing, the first component is the connector housing, which has a flange and a first through-hole formed in the flange; and
the second component is a mounting panel and is formed with a mounting opening that allows a portion of the connector to pass through, the mounting opening of the second component has a rolled edge to prevent deformation of the edge of the mounting opening when tightening the bolt.

25. A product installation method, comprising following steps:
S10: providing the pull-type riveting assembly as claimed in claim 1;
S20: pre installing the pull-type riveting assembly onto a first component of a product;
S30: passing the rivet body of the riveting nut through a second through-hole of a second component; and
S40: using a riveting tool to tighten the bolt of the pull-type riveting assembly to rivet the riveting nut to the second component and tighten the first component to the second component.
